(19) United States
(12) Patent Application Publication
(10) Pub. No.: US 2008/0169700 A1
(43) Pub. Date: Jul. 17, 2008

(54) Fluid Braking System

(76) Inventor: Dayton L. Poss, Homer, AK (US)

Correspondence Address: NEUSTEL LAW OFFICES, LTD., 2534 SOUTH UNIVERSITY DRIVE, SUITE 4, FARGO, ND, 58103, US

(21) Appl. No.: 11/623,904

(22) Filed: Jan. 17, 2007

(51) Int. Cl. B60T 13/16

(52) U.S. Cl. 303/10; 701/70

(57) ABSTRACT

A fluid braking system for efficiently transferring a substantial amount of energy utilized when braking a vehicle to energy utilized for accelerating the vehicle. The fluid braking system generally includes a storage tank including hydraulic fluid, wherein the storage tank receives the hydraulic fluid from a drive mechanism, at least one hydraulic actuator fluidly connected to the storage tank and a hydraulic accumulator fluidly connected to the hydraulic pump and the drive mechanism.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to vehicle brakes and more specifically it relates to a fluid braking system for efficiently transferring a substantial amount of energy utilized when braking a vehicle to energy utilized for accelerating the vehicle.

2. Description of the Related Art

Any discussion of the prior art throughout the specification should in no way be considered as an admission that such prior art is widely known or forms part of common general knowledge in the field.

Vehicle brakes have been in use for years and are generally devices utilized for slowing or stopping the motion of a vehicle. Typically, modern vehicle brakes are comprised of disc brakes, wherein the brakes generally include pads and a disc. The pads generally provide a tightening or sandwiching force upon the disc thus slowing the rotation of the attached wheel or axle.

The kinetic energy lost by the slowing or stopping of the moving part (i.e. wheel, axle, etc.) is generally transferred to heat or friction. Transferring the kinetic energy of the moving part to heat or friction can be considered wasteful in that the energy may be useful in other applications. Because of the general lack of efficiency and practicality in the prior art there is the need for a new and improved fluid braking system for efficiently transferring a substantial amount of energy utilized when braking a vehicle to energy utilized for accelerating the vehicle.

### BRIEF SUMMARY OF THE INVENTION

The general purpose of the present invention is to provide a fluid braking system that has many of the advantages of the vehicle brakes mentioned heretofore. The invention generally relates to vehicle brakes which include a storage tank including hydraulic fluid, wherein the storage tank receives the hydraulic fluid from a drive mechanism, at least one hydraulic actuator fluidly connected to the storage tank and a hydraulic accumulator fluidly connected between the hydraulic actuator and the drive mechanism.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a fluid braking system for efficiently transferring a substantial amount of energy utilized when braking a vehicle to energy utilized for accelerating the vehicle.

Another object is to provide a fluid braking system that reduces vehicle fuel consumption.

An additional object is to provide a fluid braking system that is adaptable to all types of vehicles.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a flow diagram of the present invention.

FIG. 2 is a flow chart of the present invention.

FIG. 3 is a flow diagram of the process of the present invention.

FIG. 4 is a flow diagram of the present invention illustrated within a vehicle.

### DETAILED DESCRIPTION OF THE INVENTION

### A. Overview

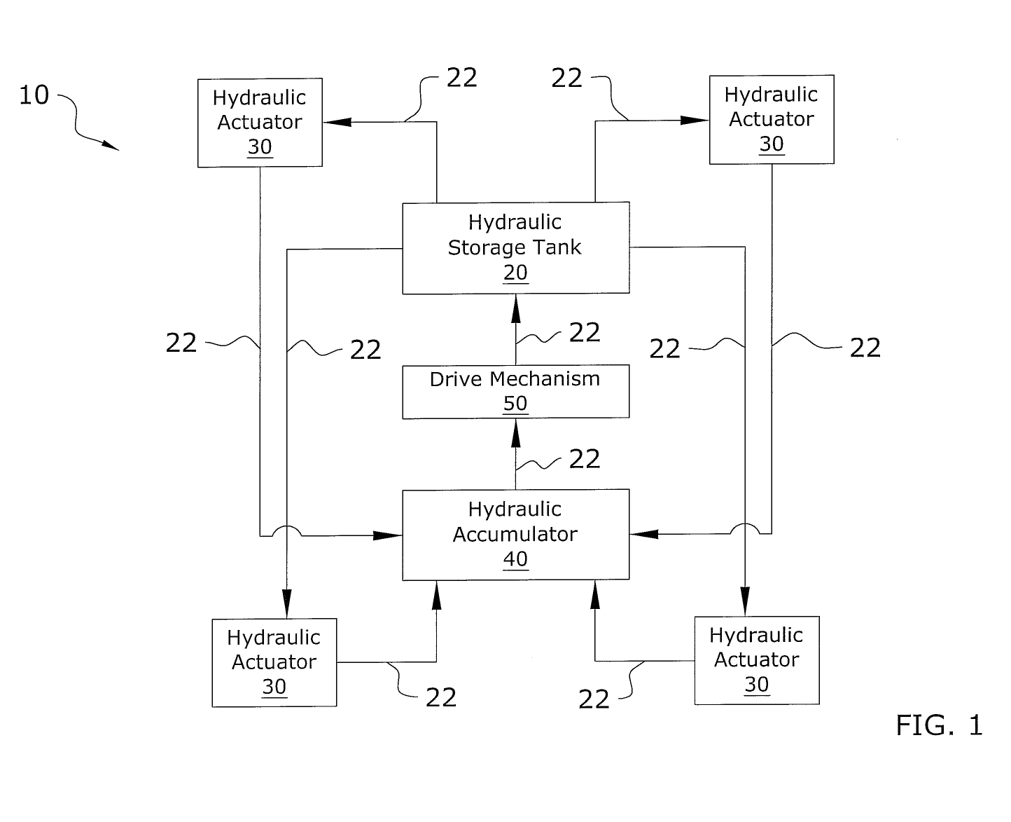

Turning now descriptively to the drawings, in which similar reference characters denote similar elements throughout the several views, FIGS. 1 through 4 illustrate a fluid braking system 10, which comprises a storage tank 20 including hydraulic fluid, wherein the storage tank 20 receives the hydraulic fluid from a drive mechanism 50, at least one hydraulic actuator 30 fluidly connected to the storage tank 20 and a hydraulic accumulator 40 fluidly connected to the hydraulic pump and the drive mechanism 50.

It is appreciated that the present invention may include a plurality of various parts rather than those described during assembly of the present invention with the vehicle 12, such as but not limited to fittings, relief valves, check valves, constant flow valves, flow control valves, electrical switches and various circuitry. The vehicle 12 also preferably includes a compression release engine brake to further assist in saving fuel and braking. It is also appreciated that the present invention may operate with the friction brakes standard upon a vehicle 12. It is further appreciated that the vehicle 12 utilized with the present invention may vary to include all types of vehicles 12.

### B. Storage Tank

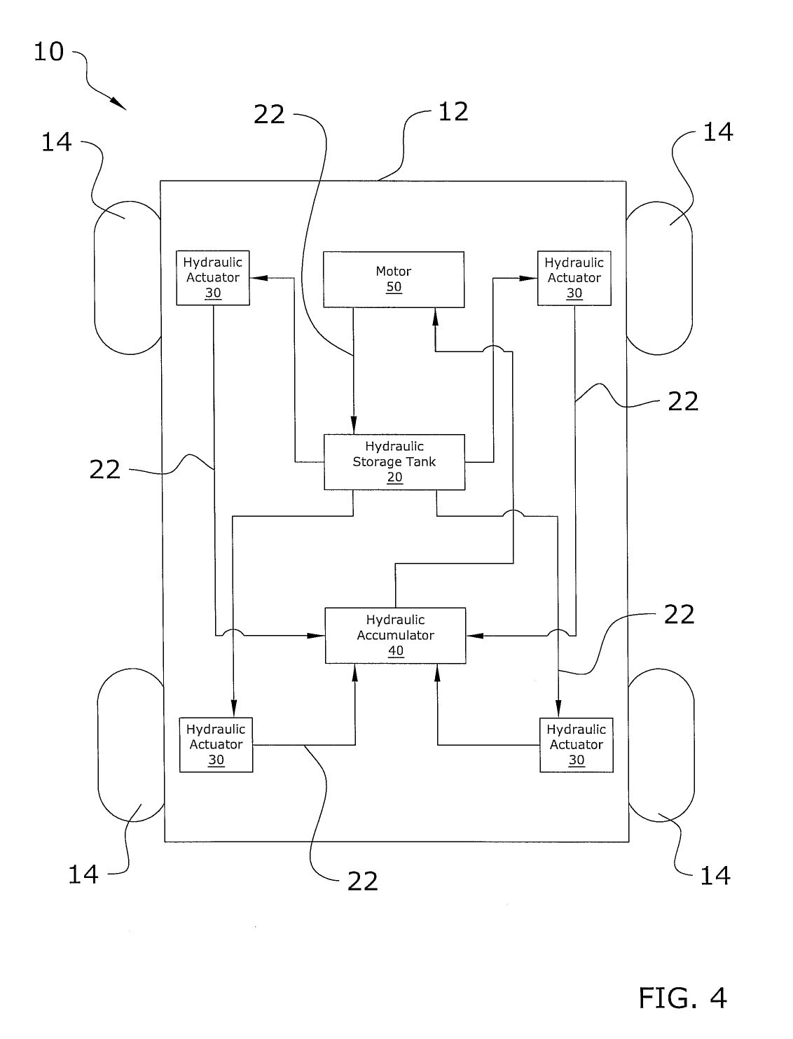

The storage tank 20 fluidly secures and transfers the hydraulic fluid. The storage tank 20 secures the hydraulic fluid when the braking mechanism or drive mechanism 50 of the vehicle 12 is not being currently engaged, such as but not limited to when the vehicle 12 is turned off or when the vehicle 12 is coasting. The storage tank 20 is preferably positioned about or attached to the vehicle 12 as illustrated in FIG. 4.

The storage tank 20 is further comprised of a large enough capacity to secure enough hydraulic fluid for the present invention to operate properly. The storage tank 20 is fluidly connected between the hydraulic actuators 30 and the drive mechanism 50, wherein the transfer of the hydraulic fluid is in the direction of the drive mechanism 50 to the storage tank 20 to the hydraulic actuators 30 as illustrated in FIGS. 1 and 4. The storage tank 20 is further preferably fluidly connected between the hydraulic actuators 30 and the drive mechanism 50 via a plurality of hydraulic hoses 22.

If a plurality of hydraulic actuators 30 are utilized the storage tank 20 is preferably fluidly connected in a parallel connection configuration to each of the hydraulic actuators 30 as illustrated in FIGS. 1 and 4. It is appreciated that the storage tank 20 may be comprised of a plurality of configurations all which adequately secure and transfer the hydraulic fluid.

### C. Hydraulic Actuator

The hydraulic actuators 30 fluidly transfer the hydraulic fluid from the storage tank 20 to the hydraulic accumulator 40 as illustrated in FIGS. 1 through 4. The hydraulic actuators 30 transfer the fluid when the braking mechanism of the vehicle 12 is being currently engaged, such as but not limited to when the vehicle 12 is slowing down or stopping. The hydraulic actuators 30 are preferably positioned about or attached to the vehicle 12.

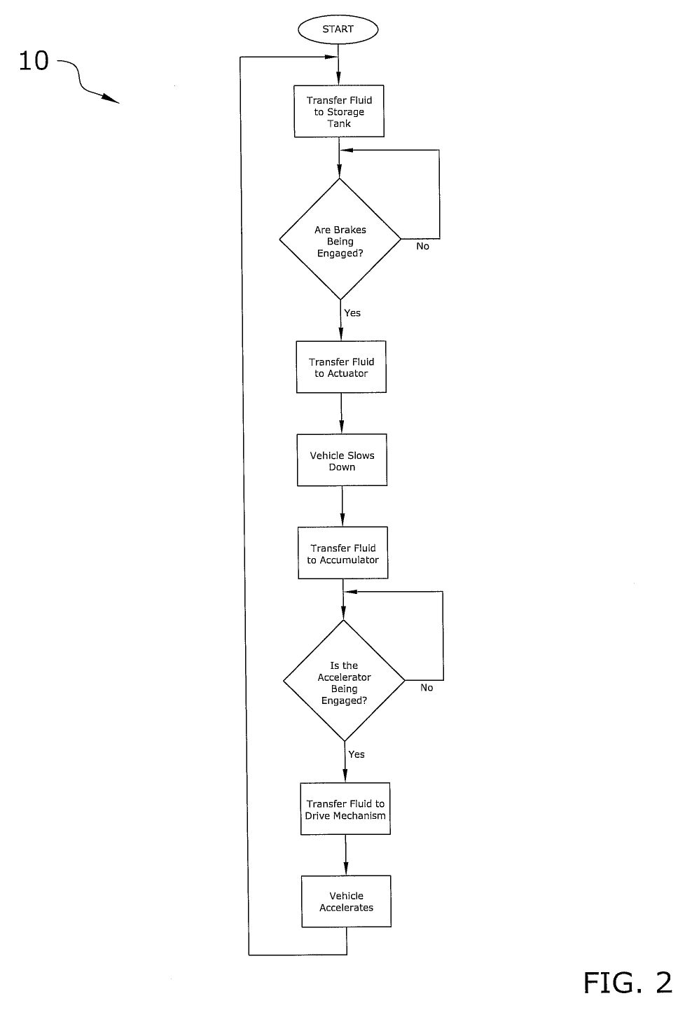

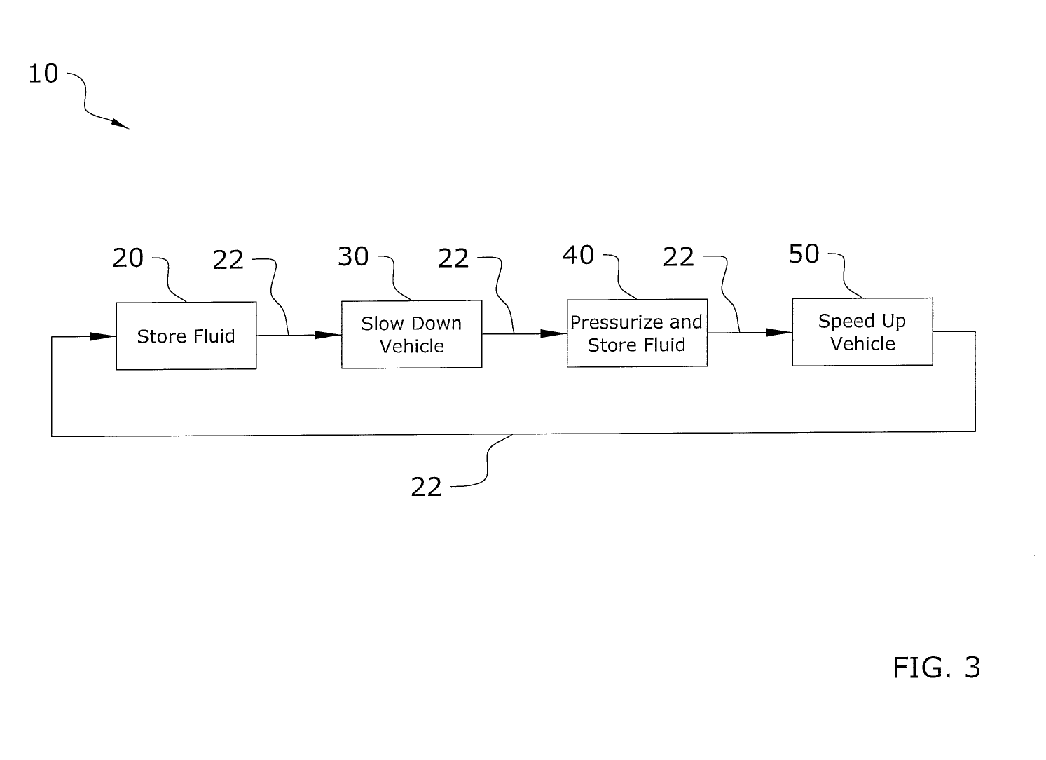

The hydraulic actuators 30 are further mechanically connected to at least one wheel 14 of the vehicle 12. The hydraulic actuators 30 are preferably comprised of a hydraulic brake structure to adequately slow down or stop the vehicle 12 when the hydraulic actuators 30 pump the hydraulic fluid as illustrated in FIGS. 2 and 3. The hydraulic actuators 30 further preferably pump the hydraulic fluid from the storage tank 20.

The structure and operation of the hydraulic actuators 30 is preferably common in the art of stopping or slowing down a rotating wheel 14 upon a vehicle 12. It is appreciated that the present invention may include anywhere from a single hydraulic actuator 30 mechanically attached to one wheel 14 to a hydraulic actuator 30 mechanically attached to every rotating wheel 14 upon a vehicle 12 as illustrated in FIG. 4.

The hydraulic actuators 30 are preferably engaged when the brake pedal or other breaking mechanism of the vehicle 12 is engaged. When the brake pedal is engaged the hydraulic actuators 30 preferably receive the fluid from the storage tank 20 via pumping the hydraulic fluid within and through the hydraulic actuators 30. When the hydraulic actuators 30 receive the hydraulic fluid they subsequently slow down the rotation of the wheels 14.

The hydraulic actuators 30 subsequently transfer the hydraulic fluid to the hydraulic accumulator 40. The hydraulic actuators 30 are further preferably fluidly connected between the storage tank 20 and the hydraulic accumulator 40 via a plurality of hydraulic hoses 22 as illustrated in FIGS. 1 and 4.

### D. Hydraulic Accumulator

The hydraulic accumulator 40 stores the energy (i.e. hydraulic fluid) utilized with the braking (i.e. hydraulic actuators 30) of the vehicle 12 to be later utilized with accelerating (i.e. driving mechanism 50) the vehicle 12. The hydraulic accumulator 40 fluidly secures and transfers the hydraulic fluid. The hydraulic accumulator 40 secures the fluid directly after the braking mechanism is engaged. The hydraulic accumulator 40 is preferably positioned about or attached to a vehicle 12. The hydraulic accumulator 40 is further preferably positioned about an out of sight area upon the vehicle 12.

The hydraulic accumulator 40 is further comprised of a large enough capacity to secure enough hydraulic fluid for the present invention to operate properly. The hydraulic accumulator 40 is fluidly connected between the hydraulic actuators 30 and the drive mechanism 50, wherein the transfer of the hydraulic fluid is in the direction of the hydraulic actuators 30 to the hydraulic accumulator 40 to the drive mechanism 50 as illustrated in FIGS. 1 and 4. The hydraulic accumulator 40 is further preferably fluidly connected between the hydraulic actuators 30 and the drive mechanism 50 via a plurality of hydraulic hoses 22.

The structure and operation of the hydraulic accumulator 40 is preferably common in the art accumulators, wherein the hydraulic accumulator 40 builds up a pressure of the hydraulic fluid when within the hydraulic accumulator 40. The pressurized hydraulic fluid is released from the hydraulic accumulator 40 preferably when the accelerator pedal of the vehicle 12 is engaged, wherein the accelerator is mechanically connected to the drive mechanism 50.

The hydraulic accumulator 40 preferably includes a release valve common in the art of accumulators. The hydraulic accumulator 40 releases the pressurized fluid to the drive mechanism 50 when the accelerator is engaged, wherein the pressure of the released hydraulic fluid is great enough to adequately assist the drive mechanism 50.

### E. Drive Mechanism

The drive mechanism 50 may be comprised of various structures, such as a motor or a transmission of a vehicle 12. The drive mechanism 50 is preferably substantially comprised of a motor or transmission common in the art of vehicles 12. The drive mechanism 50 is further preferably modified to receive the hydraulic fluid and to utilize the hydraulic fluid for an initial energy source when accelerating the vehicle 12, wherein the motor is comprised of a hydraulic motor. It is appreciated that a smaller hydraulic a smaller hydraulic motor may be utilized in conjuncture with a standard motor upon a vehicle 12, wherein the hydraulic motor would be utilized to accelerate the vehicle 12.

The drive mechanism 50 is further fluidly connected between the hydraulic accumulator 40 and the hydraulic storage tank 20, wherein the connections preferably comprised hydraulic hoses 22 as illustrated in FIGS. 1 and 4. After utilizing the hydraulic fluid as the initial energy source for accelerating the hydraulic fluid is preferably transferred back to the storage tank 20.

### F. In Use

In use, the hydraulic fluid is transferred to the hydraulic actuators 30 when the brake pedal is engaged and then transferred to the driving mechanism when the accelerator pedal is engaged as illustrated in FIG. 2. In further detail the hydraulic actuators 30 brake the vehicle 12 when receiving the hydraulic fluid and then subsequently transfer the hydraulic fluid to the hydraulic accumulator 40.

The pressure of the hydraulic fluid is thus increased within the hydraulic accumulator 40 to a desired pressure, wherein the hydraulic fluid may be effectively utilized within the drive mechanism 50. When the accelerator is engaged the pressurized hydraulic fluid is released from the hydraulic accumulator 40 and subsequently transferred to the drive mechanism 50.

The drive mechanism 50 thus utilizes the hydraulic fluid to provide an initial burst of energy for the vehicle 12, thus saving on other fuels. The hydraulic fluid is then transferred back to the storage tank 20 to be utilized when the operator once again engages the brakes as illustrated in FIGS. 2 and 3.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I claim:

1. A fluid braking system, comprising:
a storage tank including hydraulic fluid, wherein said storage tank receives said hydraulic fluid from a drive mechanism;
at least one hydraulic actuator fluidly connected to said storage tank; and
a hydraulic accumulator fluidly connected to said at least one hydraulic pump and said drive mechanism.

2. The fluid braking system of claim 1, wherein said at least one hydraulic actuator is comprised of a hydraulic brake structure.

3. The fluid braking system of claim 2, wherein said at least one hydraulic actuator is mechanically attached to a wheel of a vehicle.

4. The fluid braking system of claim 1, wherein said drive mechanism is comprised of a motor of a vehicle.

5. The fluid braking system of claim 4, wherein said motor is comprised of a hydraulic motor.

6. The fluid braking system of claim 1, wherein said drive mechanism is comprised of a transmission of a vehicle.

7. The fluid braking system of claim 1, wherein said storage tank, said at least one hydraulic actuator and said hydraulic accumulator are positioned about a vehicle.

8. The fluid braking system of claim 1, wherein said at least one hydraulic actuator includes a plurality of hydraulic actuators.

9. The fluid braking system of claim 8, wherein said at least one hydraulic actuator is mechanically attached to each wheel of a vehicle.

10. A method of operating a fluid braking system, said method comprising:
providing a storage tank including hydraulic fluid, wherein said storage tank is fluidly connected to a drive mechanism;
providing at least one hydraulic actuator fluidly connected to said storage tank;
engaging said at least one hydraulic actuator;
transferring said hydraulic fluid from said storage tank to said at least one hydraulic actuator;
providing a hydraulic accumulator fluidly connected between said at least one hydraulic actuator and said drive mechanism;
transferring said hydraulic fluid from said at least one hydraulic actuator to said hydraulic accumulator;
increasing a pressure of said hydraulic fluid within said hydraulic accumulator;
engaging said drive mechanism;
transferring said hydraulic fluid from said at least one hydraulic accumulator to said drive mechanism;
assisting operation of said drive mechanism with said hydraulic fluid; and
transferring said hydraulic fluid from said drive mechanism to said storage tank.

11. The fluid braking system of claim 10, wherein said at least one hydraulic actuator is comprised of a hydraulic brake structure.

12. The fluid braking system of claim 11, wherein said at least one hydraulic actuator is mechanically attached to a wheel of a vehicle.

13. The fluid braking system of claim 10, wherein said drive mechanism is comprised of a motor of a vehicle.

14. The fluid braking system of claim 10, wherein said drive mechanism is comprised of a transmission of a vehicle.

15. The fluid braking system of claim 10, wherein said storage tank, said at least one hydraulic actuator and said hydraulic accumulator are positioned about a vehicle.

16. The fluid braking system of claim 10, wherein said at least one hydraulic actuator includes a plurality of hydraulic actuators.

17. The fluid braking system of claim 16, wherein said at least one hydraulic actuator is mechanically attached to each wheel of a vehicle.

18. A method of operating a fluid braking system, said method comprising:
providing a vehicle including a motor;
providing a storage tank attached to said vehicle, wherein said storage tank includes hydraulic fluid and wherein said storage tank is fluidly connected to said motor;
providing at least one hydraulic actuator mechanically attached to a wheel of said vehicle, wherein said at least one hydraulic actuator is fluidly connected to said storage tank;
wherein said at least one hydraulic actuator is comprised of a hydraulic brake structure and wherein said at least one hydraulic actuator is mechanically attached said wheel of said vehicle;
engaging said at least one hydraulic actuator via a brake pedal of said vehicle;
transferring said hydraulic fluid from said storage tank to said at least one hydraulic actuator;
reducing a rotation speed of said at least one wheel via said at least one hydraulic actuator receiving said hydraulic fluid;
providing a hydraulic accumulator attached to said vehicle, wherein said hydraulic accumulator is fluidly connected between said at least one hydraulic actuator and said motor;
transferring said hydraulic fluid from said at least one hydraulic actuator to said hydraulic accumulator;
increasing a pressure of said hydraulic fluid within said hydraulic accumulator;
engaging said motor via an accelerator pedal of said vehicle;
releasing said hydraulic fluid from said hydraulic accumulator;
transferring said hydraulic fluid to said motor;
assisting operation of said motor with said hydraulic fluid;
increasing said rotation speed of said at least one wheel; and
transferring said hydraulic fluid from said motor to said storage tank.

19. The fluid braking system of claim 18, wherein said at least one hydraulic actuator includes a plurality of hydraulic actuators.

20. The fluid braking system of claim 19, wherein said at least one hydraulic actuator is mechanically attached to each wheel of a vehicle.
